(19) United States
(12) Patent Application Publication
(10) Pub. No.: US 2017/0228505 A1
(43) Pub. Date: Aug. 10, 2017

(54) System and Method for Optimizing Visualization for Comparative Treatment Analysis from a Cognitive and Personal Approach

(71) Applicant: International Business Machines Corporation, Armonk, NY (US)

(72) Inventors: Corville O. Allen, Morrisville, NC (US); Andrew R. Freed, Cary, NC (US); Zhongxiu Liu, Raleigh, NC (US); Agustin Malo, Gainesville, FL (US); Sandhya Narayan Nayak, Mumbai (IN); Mitchell W. Rees-Jones, Raleigh, NC (US); Sunil Davangere Shashidhara, Raleigh, NC (US)

(21) Appl. No.: 15/016,541

(22) Filed: Feb. 5, 2016

(51) Int. Cl. G06F 19/00; G06N 5/02; G06F 17/28

(52) U.S. Cl. CPC G06F 19/345; G06F 19/3437; G06F 17/28; G06N 5/022

(57) ABSTRACT

A method, system, and computer program product are provided for displaying tradeoff options for a plurality of items (e.g., treatment recommendations) and options (e.g., treatment outcomes) by analyzing the options based on user-specified preference data and weighting factors to identify a list of options for a comparative list of items, and then employing a user interface to display a comparison of tradeoff options for the comparative list of items as a treatment matrix which includes visual tradeoff indication for each option shared in common with the comparative list of items to assist with the comparison of tradeoff options for the comparative list of items, where the user-specified preference data and/or weighting factors may be dynamically modified through interaction with a user interface to specify importance and impact weighting factors.

### BACKGROUND OF THE INVENTION

In the field of artificially intelligent computer systems capable of answering questions posed in natural language, cognitive question answering (QA) systems (such as the IBM WatsonTM artificially intelligent computer system or and other natural language question answering systems) process questions posed in natural language to determine answers and associated confidence scores based on knowledge acquired by the QA system. Such cognitive QA systems provide powerful tools that can be used to in a variety of different applications or fields, such as financial, medical, scientific research, and the like. While there remain challenges with processing the ever increasing amount of data (such as, for example, the research data, medical records, clinical trials, etc. in the medical field), there are also significant challenges with evaluating the processing results, such as when a physician or patient needs to make treatment decisions to select from multiple, different treatment options. For example, the treatment selection process may require that a physician or patient consider the attributes or side effects of many different treatments along with the patient's medical record, but existing solutions require that a physician evaluates the many different treatments on the basis of the physician's knowledge and on-site judgment. While cognitive QA systems can provide computational power to assimilate and analyze the meaning and context of structured and unstructured data (such as clinical notes, reports, and key patient information) to generate a wealth of candidate treatment option recommendations, the clinical decision making process can actually be impaired since the large amount of information on the candidate treatment options makes it difficult for physicians to deliver the interpretations and for patients to understand the outcomes associated with treatment options. Existing solutions for personalizing the clinical decision-making process have been limited to providing content-level optimization, such as by incorporating information about a patient's life style and preference(s) into the selection of the treatments or by using the personal profile and keyword weights to select content topics, but such solutions do not optimize the visual display of information to assist with the clinical decision-making process. As a result, the existing solutions for efficiently and accurately processing and evaluating large and complex amounts of information, such as treatment options, are extremely difficult at a practical level.

### SUMMARY

Broadly speaking, selected embodiments of the present disclosure provide a system, method, and apparatus for optimizing the display or visualization of tradeoff options (e.g., treatment outcomes, such as cost or side effect) for a plurality of items (e.g., treatment recommendations) by using specified input parameters and the cognitive power of the information handling system to generate, select, and comparatively display tradeoff options for a comparative list of items along with a visual tradeoff indication for each option shared in common with the comparative list of items. As an initial step in selected embodiments of the present disclosure, the information handling system identifies, retrieves, processes, and/or combines data from the patient's profile and/or preference selections with diagnostic data from the physician (such as clinical expertise, external research, and other medical data) by applying one or more learning methods to identify potential treatment plans or recommendations (items) for a patient based on patient-selected preferences or the selection history of other patients having a similar demographic background and/or medical history. Rather than display all potential treatment plans, the information handling system applies patient-specified preference parameters, alone or in combination with one or more distinction or impact factors, to select and display a personalized visualization of treatment outcomes (options), where the content and/or style of the personalized visualization of treatment outcomes may be dynamically optimized to provide the user with a personalized, efficient, and intuitive visualization, thereby assisting the decision-making by the physician and patient when considering the treatment plans or recommendations provided by the information handling system when making decisions for individual patients. By personalizing both the selection of content and the visual display thereof, the present disclosure may be used to optimize the visualization of comparative treatment analysis from both a cognitive and personalized basis to provide an efficient and intuitive user interface for users. Such an optimized visualization can assist users to better focus on the most important information when assessing large amounts of complex information. For example, the optimized visualization can increase the efficiency in clinical decision-making by reducing patient's memory load, and driving clinical discussions to focus on most important factors first. Moreover, the importance of information in the decision-making process can be formulated by both the cognitive system and user profile to enhance the personalized experience during clinical decision.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a system diagram that includes a QA system connected in a network environment that uses a treatment visualization engine to optimize the display or visualization of personalized treatment options based on patient-selected parameters;

FIG. 2 is a block diagram of a processor and components of an information handling system such as those shown in FIG. 1;

FIG. 3 is a block diagram illustration of a user interface and different user actions that can be performed through the user interface to dynamically personalize the display of personalized treatment options;

FIG. 4 is a block diagram illustration of a machine learning process used to generate a list of treatments and outcomes; and

FIG. 5 is a simplified block diagram flow chart showing the logic for optimizing the visualization content and style used to comparatively display personalized treatment options based on patient-selected factors and visualization attributes of outcomes.

### DETAILED DESCRIPTION

The present invention may be a system, a method, and/or a computer program product. In addition, selected aspects of the present invention may take the form of an entirely hardware embodiment, an entirely software embodiment (including firmware, resident software, micro-code, etc.) or an embodiment combining software and/or hardware aspects that may all generally be referred to herein as a “circuit,” “module” or “system.” Furthermore, aspects of the present invention may take the form of computer program product embodied in a computer readable storage medium (or media) having computer readable program instructions thereon for causing a processor to carry out aspects of the present invention. Thus embodied, the disclosed system, a method, and/or a computer program product is operative to improve the functionality and operation of a cognitive question answering (QA) systems by optimizing the display or visualization of personalized treatment options generated by a cognitive QA system to provide a more efficient and intuitive clinical decision-making interface.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

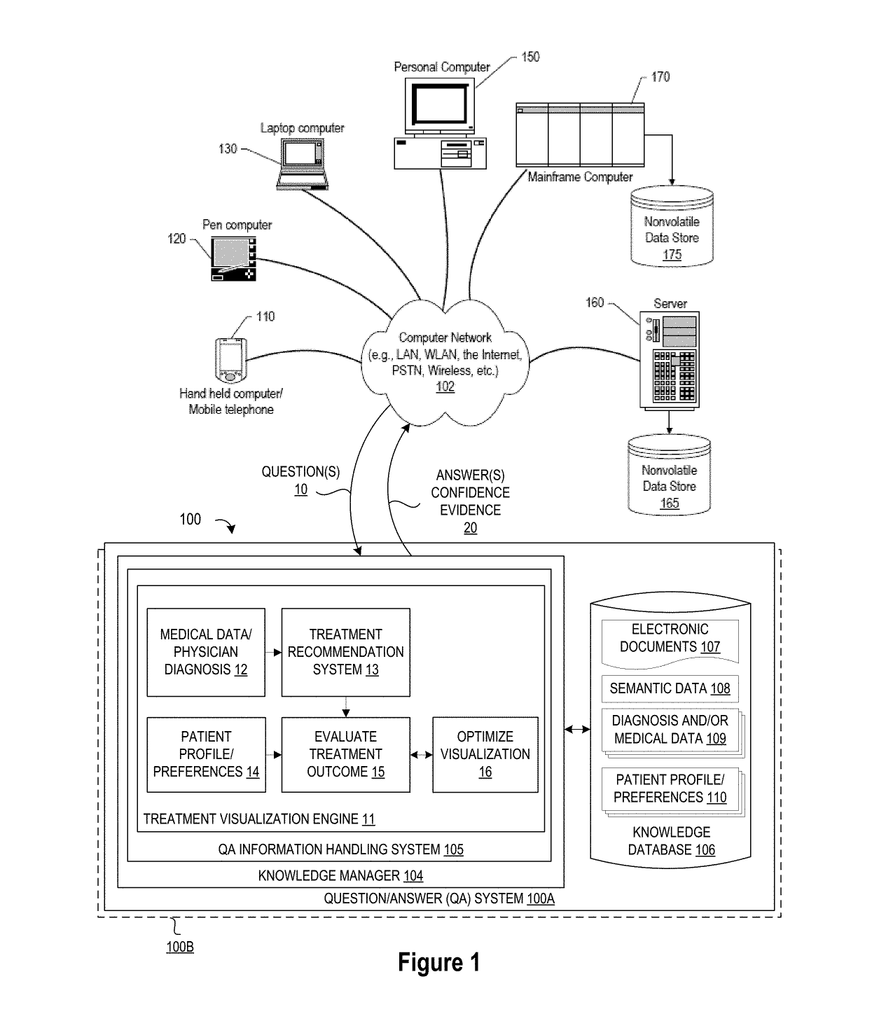

FIG. 1 depicts a schematic diagram of one illustrative embodiment of a question/answer (QA) system 100 connected across a computer network 102 to a plurality of computing devices (e.g., 110, 120, 130), where the QA system 100 uses a treatment visualization engine 11 to optimize the display or visualization of personalized treatment options. The QA system 100 may include one or more QA system pipelines 100A, 100B, each of which includes a knowledge manager computing device 104 (comprising one or more processors and one or more memories, and potentially any other computing device elements generally known in the art including buses, storage devices, communication interfaces, and the like) for processing questions received over the network 102 from one or more users at computing devices (e.g., 110, 120, 130). Over the network 102, the computing devices communicate with each other and with other devices or components via one or more wired and/or wireless data communication links, where each communication link may comprise one or more of wires, routers, switches, transmitters, receivers, or the like. In this networked arrangement, the QA system 100 and network 102 may enable question/answer (QA) generation functionality for one or more content users. Other embodiments of QA system 100 may be used with components, systems, sub-systems, and/or devices other than those that are depicted herein.

In the QA system 100, the knowledge manager 104 may be configured to receive inputs from various sources. For example, knowledge manager 104 may receive input from the network 102, one or more knowledge bases or corpora 106 of electronic documents 107, semantic data 108, or other data, content users, and other possible sources of input. In selected embodiments, the knowledge base 106 may include structured, semi-structured, and/or unstructured content in a plurality of documents that are contained in one or more large knowledge databases or corpora. The various computing devices (e.g., 110, 120, 130) on the network 102 may include access points for content creators and content users. Some of the computing devices may include devices for a database storing the corpus of data as the body of information used by the knowledge manager 104 to generate answers to cases. The network 102 may include local network connections and remote connections in various embodiments, such that knowledge manager 104 may operate in environments of any size, including local and global, e.g., the Internet. Additionally, knowledge manager 104 serves as a front-end system that can make available a variety of knowledge extracted from or represented in documents, network-accessible sources and/or structured data sources. In this manner, some processes populate the knowledge manager with the knowledge manager also including input interfaces to receive knowledge requests and respond accordingly.

In one embodiment, the content creator creates content in an electronic document 107 for use as part of a corpora 106 of data with knowledge manager 104. The corpora 106 may include any structured and unstructured documents, including but not limited to any file, text, article, or source of data (e.g., scholarly articles, dictionary definitions, encyclopedia references, and the like) for use in knowledge manager 104. Content users may access knowledge manager 104 via a network connection or an Internet connection to the network 102, and may input questions to knowledge manager 104 that may be answered by the content in the corpus of data. As will be appreciated, when a process evaluates a given section of a document for semantic content, the process can use a variety of conventions to query it from the knowledge manager. One convention is to send a well-formed question 10. Semantic content is content based on the relation between signifiers, such as words, phrases, signs, and symbols, and what they stand for, their denotation, or connotation. In other words, semantic content is content that interprets an expression, such as by using Natural Language (NL) Processing. In one embodiment, the process sends well-formed questions 10 (e.g., natural language questions, etc.) to the knowledge manager 104. Knowledge manager 104 may interpret the question and provide a response to the content user containing one or more answers 20 to the question 10. In some embodiments, knowledge manager 104 may provide a response to users in a ranked list of answers 20.

In some illustrative embodiments, QA system 100 may be the IBM Watson™ QA system available from International Business Machines Corporation of Armonk, N.Y., which is augmented with the mechanisms of the illustrative embodiments described hereafter. The IBM Watson™ knowledge manager system may receive an input question 10 which it then parses to extract the major features of the question, that in turn are then used to formulate queries that are applied to the corpus of data stored in the knowledge base 106. Based on the application of the queries to the corpus of data, a set of hypotheses, or candidate answers to the input question, are generated by looking across the corpus of data for portions of the corpus of data that have some potential for containing a valuable response to the input question.

In particular, a received question 10 may be processed by the IBM Watson™ QA system 100 which performs deep analysis on the language of the input question 10 and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the IBM Watson™ QA system. The statistical model may then be used to summarize a level of confidence that the IBM Watson™ QA system has regarding the evidence that the potential response, i.e., candidate answer, is inferred by the question. This process may be repeated for each of the candidate answers until the IBM Watson™ QA system identifies candidate answers that surface as being significantly stronger than others and thus, generates a final answer, or ranked set of answers, for the input question. The QA system 100 then generates an output response or answer 20 with the final answer and associated confidence and supporting evidence. More information about the IBM Watson™ QA system may be obtained, for example, from the IBM Corporation website, IBM Redbooks, and the like. For example, information about the IBM Watson™ QA system can be found in Yuan et al., “Watson and Healthcare,” IBM developerWorks, 2011 and “The Era of Cognitive Systems: An Inside Look at IBM Watson and How it Works” by Rob High, IBM Redbooks, 2012. Another example QA system 100 is the IBM Watson for Oncology™ cognitive computing system which is designed to support oncology physicians as they consider treatment options with their patients by analyzing a patient's medical information against a vast array of data and expertise to interpret the cancer patients' clinical information and identify individualized, evidence-based treatment options.

To process and answer questions, the QA system 100 may include an information handling system 105 which uses a treatment visualization engine 11 to optimize the display of personalized treatment options by identifying potential treatment plans or recommendations for a patient using machine learning techniques, and then displaying selected treatment plans or recommendations based on patient-selected parameters and/or specified distinction or impact factors in the course of generating, selecting, and displaying treatment options for comparison and evaluation by the patient. Though shown as being embodied in or integrated with the QA system 100, the information handling system 105 and/or treatment visualization engine 11 may be implemented in a separate computing system (e.g., 150) that is connected across a network 102 to the QA system 100. Wherever embodied, the cognitive power of the treatment visualization engine 11 processes input data from the physician diagnosis and patient medical data to generate candidate treatment recommendations, evaluates the candidate treatment recommendations on the basis of treatment outcomes specified by the patient profile or preference data, and then generates an optimized visualization of the treatment recommendations based on the patient-specified treatment outcomes.

In selected example embodiments, the treatment visualization engine 11 may include a medical data input source or interface 12 for receiving medical information or data, such as the diagnostic data from the physician, clinical expertise, external research, or other medical data. Examples of such input data include, but are not limited to basic patient demographic information (e.g., age and gender), the patient's electronic medical record (e.g., vitals, problems/diagnoses, medications, allergies, patient charts, documents, vaccinations, lab results, confidential notes, images, etc.), and/or the patient's diagnosis result (e.g., current tumor size or prognosis). As an alternative to providing an input interface 12, the physician's diagnosis data may have already been stored by the QA system 100 during the patient's previous visit.

Upon receiving or otherwise obtaining the input medical data, the treatment visualization engine 11 may be configured to generate treatment recommendations based on the medical data. To this end, the treatment visualization engine 11 may include a treatment recommendation system 13 that is configured to apply natural language processing (NLP) techniques, such as machine learning and/or deep analytic analysis, to suggest treatments/outcomes to include based on the patient's demographical and medical information. As described in more detail with reference to FIG. 4, the treatment recommendation system 13 may be configured to apply one or more learning methods to evaluate patient's medical data and diagnostic data from the physician and to generate therefrom recommend treatments for this medical case, where each recommended treatment includes one or more specified treatment outcomes, such as potential side-effects, cost, and patient's survival rate. Typically, the output generated by the treatment recommendation system 13 may include multiple, different treatment options that can overwhelm the physician or patient's decision-making process which must consider the attributes or side effects of the many disparate treatments along with the patient's personal medical record information, particularly in the stressful context of making health decisions when the patient is stressed, injured, or sick.

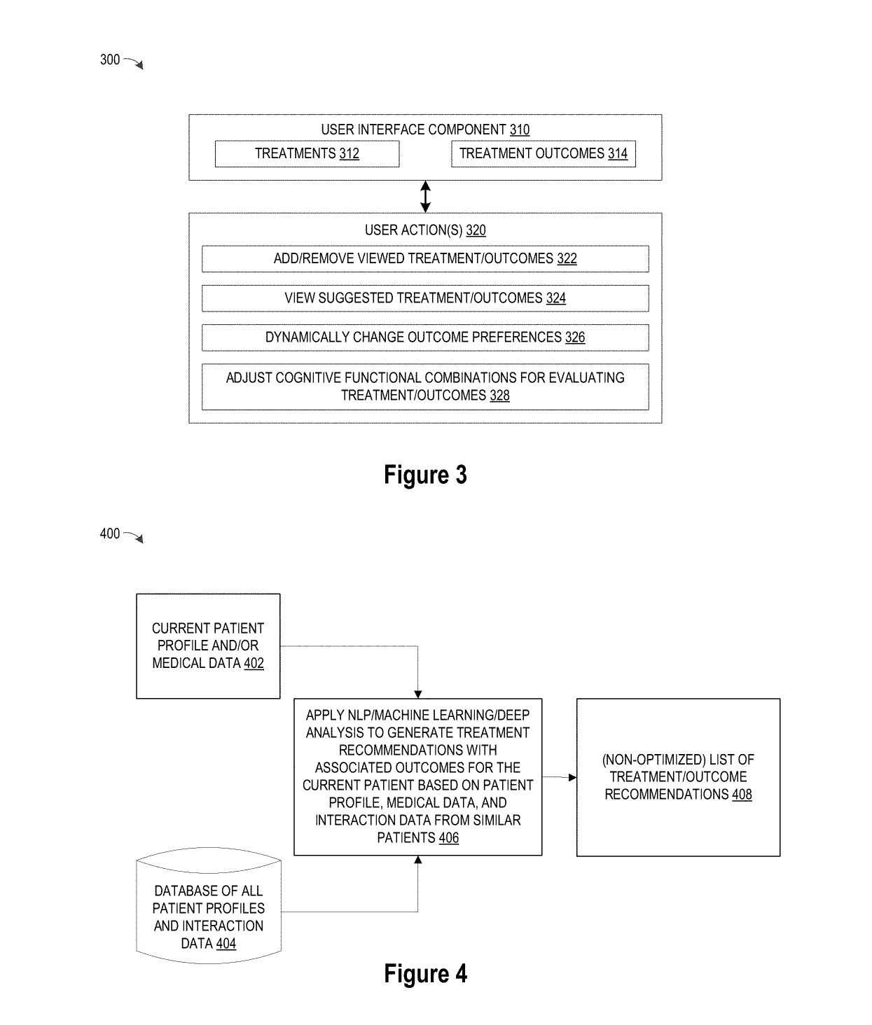

To help select or narrow the number of treatment recommendations being considered, the treatment recommendations may be processed by the treatment visualization engine 11 by evaluating the treatment outcome(s) for each recommended treatment. To this end, the treatment visualization engine 11 may include a treatment outcome evaluator 15 that is configured to determine the display priority and visualization attributes of outcomes for each recommended treatment from the treatment recommendation system 13 based on the patient profile preference data collected at the patient preference input source or interface 14. The evaluation performed by the treatment outcome evaluator 15 may use patient profile and/or preference data 14 to choose or select which treatment outcomes are important to the patient. For example and as described in more detail with reference to FIG. 3, the patient profile and/or preference data 14 may be collected through a user interface component which the physician or patient may use to specify treatments or treatment outcomes by specifying or dynamically changing the patient's outcome preferences. For example, the patient profile and/or preference data 14 may be used to specify that a “hair loss” treatment outcome is not important to a patient whose profile or preferences indicate that the patient is bald. In another example, the patient profile and/or preference data 14 may be used to specify that an “external catheter bag” treatment outcome is important to a patient whose profile or preferences indicate that the patient is an active bicycle rider or jogger.

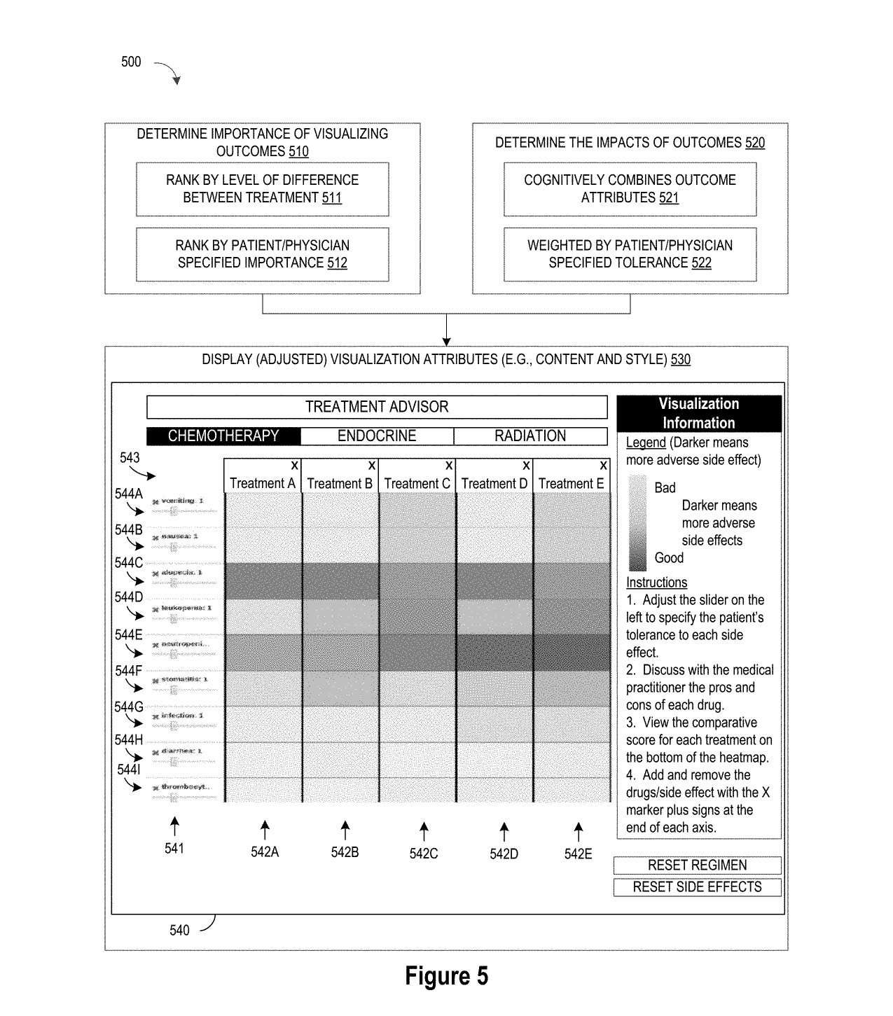

In addition or in the alternative, the treatment outcome evaluator 15 may evaluate and prioritize treatment outcomes for display on the basis of user interaction with a cognitive matrix interface which visually conveys treatment outcomes with visual attributes (e.g., a color from a range of colors) that combine one or more outcome attributes (e.g., the severity and the frequency) for a given treatment outcome. For example and as described in more detail with reference to FIG. 5, the optimized visualization content may include a cognitive matrix which may be displayed for interaction with the user as a matrix of treatments (arranged in columns) with corresponding treatment outcomes (e.g., side effects or costs), each of which is displayed with a visual attribute in one or more rows of each treatment column.

Based on interactions with the user profile and/or preference selection inputs, the evaluated treatment recommendations may be displayed by the treatment visualization engine 11 as an optimized visualization of the treatment recommendations for the patient. To this end, the treatment visualization engine 11 may include a visualization optimizer 16 that is configured to display optimized visualization of the treatment recommendations for the patient. The optimized visualization generated by the visualization optimizer 16 may specify the content and style for conveying comparative treatment options, such as by generating a cognitive matrix interface with treatment options presented in each column and with associated treatment outcomes for each treatment presented in the rows of each treatment. In selected embodiments, a displayed treatment outcome in a given row may visually convey a plurality of outcome attributes with a single visual attribute (e.g., a color from a range of colors or some other graphical representation) representing a cognitive functional combination of a plurality of outcome attributes. For example, a color or numeric value may be generated as a cognitive functional combination of two outcome attributes (e.g., the severity of an outcome and the likelihood of the outcome) which may be combined with any desired combination approach (e.g., averaging, multiplying, machine-learned weighted averaging, etc.).

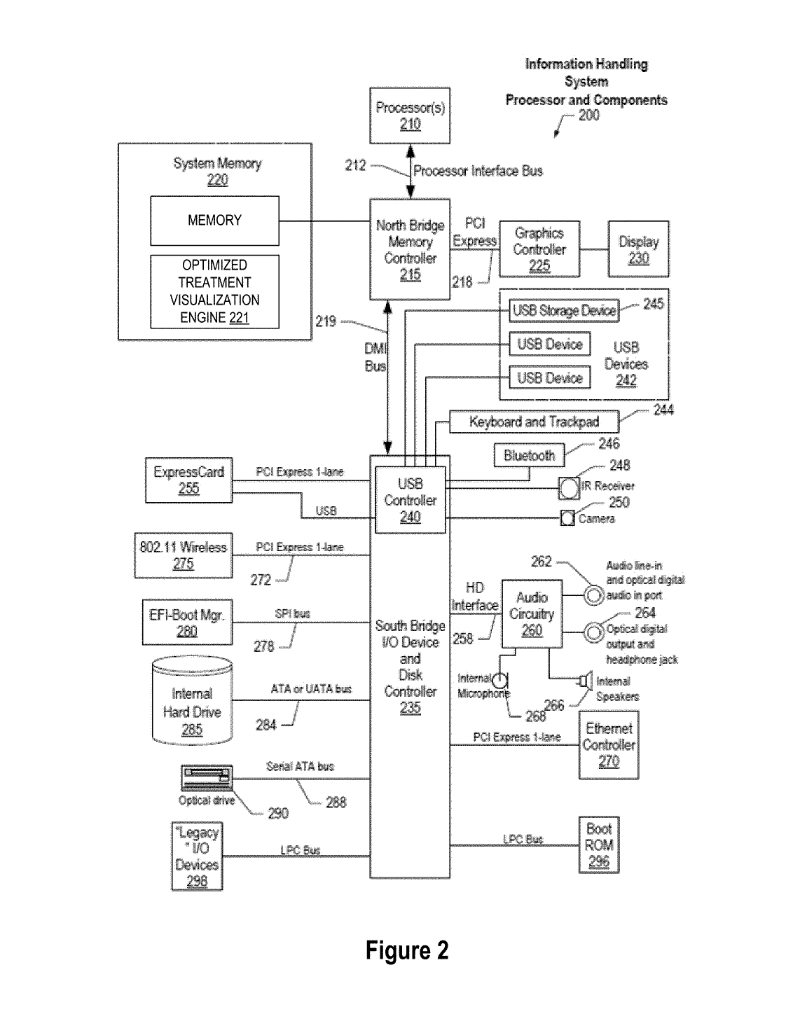

Types of information handling systems that can utilize QA system 100 range from small handheld devices, such as handheld computer/mobile telephone 110 to large mainframe systems, such as mainframe computer 170. Examples of handheld computer 110 include personal digital assistants (PDAs), personal entertainment devices, such as MP3 players, portable televisions, and compact disc players. Other examples of information handling systems include pen, or tablet, computer 120, laptop, or notebook, computer 130, personal computer system 150, and server 160. As shown, the various information handling systems can be networked together using computer network 102. Types of computer network 102 that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems may use separate nonvolatile data stores (e.g., server 160 utilizes nonvolatile data store 165, and mainframe computer 170 utilizes nonvolatile data store 175). The nonvolatile data store can be a component that is external to the various information handling systems or can be internal to one of the information handling systems. An illustrative example of an information handling system showing an exemplary processor and various components commonly accessed by the processor is shown in FIG. 2.

FIG. 2 illustrates information handling system 200, more particularly, a processor and common components, which is a simplified example of a computer system capable of performing the computing operations described herein. Information handling system 200 includes one or more processors 210 coupled to processor interface bus 212. Processor interface bus 212 connects processors 210 to Northbridge 215, which is also known as the Memory Controller Hub (MCH). Northbridge 215 connects to system memory 220 and provides a means for processor(s) 210 to access the system memory. In the system memory 220, a variety of programs may be stored in one or more memory device, including an optimized treatment visualization engine module 221 which may be invoked to dynamically optimize the displayed content and style of comparative treatment recommendations based on patient-specified preferences or profile data. Graphics controller 225 also connects to Northbridge 215. In one embodiment, PCI Express bus 218 connects Northbridge 215 to graphics controller 225. Graphics controller 225 connects to display device 230, such as a computer monitor.

Northbridge 215 and Southbridge 235 connect to each other using bus 219. In one embodiment, the bus is a Direct Media Interface (DMI) bus that transfers data at high speeds in each direction between Northbridge 215 and Southbridge 235. In another embodiment, a Peripheral Component Interconnect (PCI) bus connects the Northbridge and the Southbridge. Southbridge 235, also known as the I/O Controller Hub (ICH) is a chip that generally implements capabilities that operate at slower speeds than the capabilities provided by the Northbridge. Southbridge 235 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 296 and “legacy” I/O devices (using a “super I/O” chip). The “legacy” I/O devices (298) can include, for example, serial and parallel ports, keyboard, mouse, and/or a floppy disk controller. Other components often included in Southbridge 235 include a Direct Memory Access (DMA) controller, a Programmable Interrupt Controller (PIC), and a storage device controller, which connects Southbridge 235 to nonvolatile storage device 285, such as a hard disk drive, using bus 284.

ExpressCard 255 is a slot that connects hot-pluggable devices to the information handling system. ExpressCard 255 supports both PCI Express and USB connectivity as it connects to Southbridge 235 using both the Universal Serial Bus (USB) the PCI Express bus. Southbridge 235 includes USB Controller 240 that provides USB connectivity to devices that connect to the USB. These devices include webcam (camera) 250, infrared (IR) receiver 248, keyboard and trackpad 244, and Bluetooth device 246, which provides for wireless personal area networks (PANs). USB Controller 240 also provides USB connectivity to other miscellaneous USB connected devices 242, such as a mouse, removable nonvolatile storage device 245, modems, network cards, ISDN connectors, fax, printers, USB hubs, and many other types of USB connected devices. While removable nonvolatile storage device 245 is shown as a USB-connected device, removable nonvolatile storage device 245 could be connected using a different interface, such as a Firewire interface, etc.

Wireless Local Area Network (LAN) device 275 connects to Southbridge 235 via the PCI or PCI Express bus 272. LAN device 275 typically implements one of the IEEE 802.11 standards for over-the-air modulation techniques to wireless communicate between information handling system 200 and another computer system or device. Extensible Firmware Interface (EFI) manager 280 connects to Southbridge 235 via Serial Peripheral Interface (SPI) bus 278 and is used to interface between an operating system and platform firmware. Optical storage device 290 connects to Southbridge 235 using Serial ATA (SATA) bus 288. Serial ATA adapters and devices communicate over a high-speed serial link. The Serial ATA bus also connects Southbridge 235 to other forms of storage devices, such as hard disk drives. Audio circuitry 260, such as a sound card, connects to Southbridge 235 via bus 258. Audio circuitry 260 also provides functionality such as audio line-in and optical digital audio in port 262, optical digital output and headphone jack 264, internal speakers 266, and internal microphone 268. Ethernet controller 270 connects to Southbridge 235 using a bus, such as the PCI or PCI Express bus. Ethernet controller 270 connects information handling system 200 to a computer network, such as a Local Area Network (LAN), the Internet, and other public and private computer networks.

While FIG. 2 shows one information handling system, an information handling system may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory. In addition, an information handling system need not necessarily embody the north bridge/south bridge controller architecture, as it will be appreciated that other architectures may also be employed.

To provide additional details for an improved understanding of selected embodiments of the present disclosure, reference is now made to FIG. 3 which diagrammatically illustrates in block diagram form a user interface component 310 and different user actions 320 that can be performed through the user interface component 310 to dynamically personalize the display of personalized treatment options. As disclosed herein, the generation and display of the user interface component 310 and the processing of user interactions therewith may be performed by a cognitive system, such as the QA system 100 or any suitable information handling system.

In the user interface component 310, one or more treatments 312 may be displayed for a particular patient along with associated treatment outcomes 314. For example, the treatment recommendations 312 displayed at the user interface component 310 may include an exercise regimen, scheduled physician appointment(s), and one or more different medication prescription s for addressing the patient's medical condition. In this example, the treatment outcomes 314 displayed at the user interface component 310 may include a visual indication of one or more treatment outcomes, such as an associated cost, side effect, incidence (frequency) and severity. When configured as dynamic and interactive user interface 310, the treatments 312 and treatment outcomes 314 may be changed or modified in response to user actions 320. For example, one or more treatment and/or treatment outcomes may be added or removed from the displayed listing of treatments 312 and outcomes 314 at the user interface 310 in response to user interaction 322 to add or delete a treatment or outcome. This interactive use feature 322 allows users to add and/or minimize display content by adding/erasing treatment/outcome options from the treatment/outcome visualizations 312, 314, thereby helping users reduce memory load during comparative analysis. An example of such a user interaction 322 would be the user manipulation of a “delete” button or equivalent icon to remove one or more displayed treatments from consideration by the patient.

In another example, one or more treatments and associated outcomes may be added to the displayed listing of treatment/outcomes 312, 314 of the user interface 310 in response to user interaction 324 to view or select suggested treatment/outcomes. This interactive use feature 324 allows users to add suggested treatment options to the treatment visualization 312 which were considered or selected by other patients with similar demographic information and/or medical history, thereby informing users of the decision process of other similarly-situated patients. An example of such a user interaction 324 would be the user manipulation of a “suggestion” button or icon to generate and display one or more additional treatment recommendations for consideration by the patient.

In another example, one or more treatment outcome preferences may be dynamically changed in response to user interaction 326 to modify the displayed listing of treatment/outcomes 312, 314 of the user interface 310. This interactive use feature 326 allows users to dynamically specify or alter their individual tolerance to particular treatment outcomes, thereby helping users compare treatments dynamically with personalized specification of their individual tolerance for particular treatment outcomes. An example of such a user interaction 326 would be the user manipulation of a “slider” icon at the user interface 310 to select how important a particular treatment outcome (e.g., hair loss) is to the patient.

In another example, the specific cognitive functional combinations used to display the listing of treatment/outcomes 312, 314 of the user interface 310 may be dynamically changed or adjusted in response to user interaction 328. This interactive use feature 328 allows users to dynamically specify or modify the visual attributes (e.g., a color from a range of colors) that combine one or more outcome attributes (e.g., the severity and the frequency) for a given treatment outcome, thereby helping users interactively compare treatments with personalized specifications of their individual tolerance for particular treatment outcomes. An example of such a user interaction 328 would be the user manipulation of a numeric value or “slider” icon at the user interface 310 to adjust the weight used to combine outcome attribute in a cognitive matrix. By enabling the user to assign a higher weight on certain attributes of outcomes, such as the incidence range of a side effect, the user personalize certain attributes as more important than others during the comparative analysis.

To provide additional details for an improved understanding of selected embodiments of the present disclosure, reference is now made to FIG. 4 which diagrammatically illustrates in block diagram form a machine learning process 400 used to process patient profile information 402, 404 and generate therefrom a list of treatment recommendations and associated outcomes 408. As disclosed herein, the generation of treatment recommendations and outcomes in the process 400 may be performed by a cognitive system, such as the QA system 100 or any suitable information handling system.

As an initial step in the process 400, profile and/or medical data information from the current patient is assembled or retrieved at step 402. In selected embodiments, the assembled patient information may include patient profile data (e.g., age and gender), clinical data, diagnostic data, medical data (e.g., referral requests, patient allergies, prescription renewals, lab reports, and other patient health data), and/or any health-related data, including but not limited to patient medical records, patient entered information, care team entered information, healthcare device generated information, billing information, etc.

With the assembled patient profile/medical data, the process 400 may then search a patient database 404 to find other patients with similar profiles and then retrieve interaction data for the matching or similar patients. The retrieved interaction data may include the treatments and/or outcomes that were viewed or compared by these matching or similar patients. The interaction data may also include the search history for such matching or similar patients (e.g., what these similar patients searched and added into their comparative visualization).

At step 406, a natural language processing (NLP) technique, such as machine learning and/or deep analytic analysis, may be applied to generate treatment recommendations with associated treatment outcomes based on the current patient's demographic or profile information and medical data, alone or in combination with interaction data from similar or matching patients. In selected example embodiments, NLP-based machine learning techniques applied at step 406 may invoke association rules and/or pattern recognition logic which process interaction data for similar or matching patients to generate the treatment recommendations having associated treatment outcomes for the current patient case. As a result, a breast cancer survivor who is considering different treatments for oral cancer would be able to add in that patient's optimized visualization the recommended treatments and associated outcomes for other breast cancer survivors in the same situations, along with information about what treatments and outcomes these other similarly situated patients frequently compared or searched. With knowledge of the treatments and outcomes from similar patients available for comparison, she is able to consider the similar experiences during her decision-making process.

At step 408, the generated treatment recommendations and outcomes may be presented as a list for additional processing in which the visualization of the recommended treatments and outcomes is personalized for the patient. In this sense, the treatment/outcome list at step 408 is a non-optimized list of the multiple, different treatment options that could very well overwhelm the physician or patient's decision-making process.

To provide additional details for an improved understanding of selected embodiments of the present disclosure, reference is now made to FIG. 5 which diagrammatically illustrates a simplified block diagram flow chart 500 showing the logic for optimizing the visualization content and style used to comparatively display personalized treatment options based on patient-selected factors and user-adjustable visualization attributes of outcomes. As disclosed herein, the generation and display of optimized treatment recommendations and outcomes in the process 500 may be performed by a cognitive system, such as the QA system 100 or any suitable information handling system.

As one step in the process 500, the assembled list of recommended treatments and outcomes may be processed at step 510 to determine the importance of visualizing treatment outcomes for the patient. To this end, the information handling system may be configured to execute an algorithm that optimizes the visualization of treatment recommendations by identifying and quantifying high-importance treatment outcomes to the patient for use in selecting the associated treatment recommendations for display. With this approach, outcome importance data may be determined with a difference ranking step 511 may be applied to rank the treatment outcomes based on how much each outcome acts as a distinguish factor when comparing between treatments. For example, the difference ranking step 511 may assign a higher rank to a side effect (outcome) that has different incidence ranges than is assigned to other side effects having the same incidence range across the treatments compared. In addition or in the alterative, outcome importance data may be determined with an importance ranking step 512 may be applied to rank the treatment outcomes based on patient-specified indications of the importance of the outcome to the patient. For example, the importance ranking step 512 may sort equally ranked outcomes from step 511 based on the patient or physician's specified preference for how important the outcome is to the patient or physician.

As another step in the process 500, the assembled list of recommended treatments and outcomes may be processed at step 520 to determine the impacts of treatment outcomes for the patient. To this end, the information handling system may be configured to execute an algorithm that optimizes the visualization of treatment recommendations by selecting treatment recommendations for comparative display to the patient based by quantifying or otherwise determining the impact of treatment outcomes. The higher the impact, the more important role the outcome plays in the treatment decision, and therefore the greater likelihood of displaying the associated treatment in the optimized visualization. In addition, the impact can be dynamically adjusted by the user. With this approach, outcome impact data may be determined with a cognitive function step 521 which is applied to weight and combine the attributes of an outcome, such as combining incidence range and severity from a side effect. For example, the cognitive function step 521 may enable the user to adjust the weight used to combine the treatment outcome factors, such as by assigning a higher weight to an “incidence range” outcome to make it a more important consideration than a “severity” outcome. In addition or in the alterative, outcome impact data may be determined with a tolerance weighting step 522 which is applied to allow the user to specify a personalized tolerance level for each treatment outcome. For example, the tolerance weighting step 522 may enable the user to specify more tolerance for a first outcome (e.g., the cost of the treatment), but less tolerance for a second outcome (e.g., a specific side effect).

With the processing at steps 510 and 520, a treatment outcome can be assigned a high/low importance (at step 510) and a high/low tolerance (at step 520). For example, a patient may think it is important to see the cost of the treatments, but is not concerned that costs will affect his/her decision. In this case, the patient can specify high importance for the “cost” treatment outcome (at step 510) and a high tolerance for the “cost” treatment outcome (at step 520). In addition, it will be appreciated that the processes for determining the importance of visualizing outcomes (step 510) and determining the impact tolerance of outcomes (step 520) can be specified by the patient or physician through an interactive user interface, or can be pre-loaded with the patient profile. At step 530, the outcome importance data and outcome impact data may be processed to display an optimized visualization of comparative treatment recommendations for consideration and review by the patient. To this end, the information handling system may be configured to execute an algorithm that generates an optimized visualization of treatment recommendations by selecting and placing treatment recommendations and outcomes for comparative display to the patient based on both the importance and the impact to the patient. An example optimized visualization is shown in FIG. 5 as the cognitive matrix interface 540 which may be displayed for interaction with the user as a matrix of recommended treatments 543 (e.g., Treatment A, Treatment B, etc.) that are arranged in columns 542A-E. Below each recommended treatment (e.g., Treatment A), the cognitive matrix interface 540 displays the corresponding treatment outcomes 544A-I as associated treatment costs or side effects, such as vomiting (544A), nausea (544B), alopecia (544C), leukopenia (544D), neutropenia (544E), stomatitis (544F), infection (544G), diarrhea (544H), or thrombocytopenia (544I).

Each depicted treatment outcome in the depicted cognitive matrix interface 540 may be displayed with a visual or numeric attribute to convey information concerning the significance of the treatment outcome. For example, each treatment outcome may be displayed with a color that is selected from a range of colors so that the darker colors visually signify more adverse side effects, while the lighter colors visually signify less significant side effects. In addition or in the alternative, each treatment outcome may be displayed as a cognitive functional combination of outcome attributes which may optionally be dynamically changed or adjusted in response to user interaction. In such embodiments, the displayed cognitive functional combination of outcome attributes may use a single color from a range of colors to combine one or more outcome attributes (e.g., the severity and the frequency) for a given treatment outcome. In addition, user interactions can manipulate a numeric value or “slider” icon (e.g., the slider icon for the treatment outcome 544A) to adjust the weight used to combine outcome attribute in a cognitive matrix. By enabling the user to assign a higher weight on certain attributes of outcomes, such as the incidence range of a side effect, the user personalize certain attributes as more important than others during the comparative analysis.

In addition to visually conveying information about the importance or severity of individual treatment outcomes, the outcome importance data and outcome impact data may be processed to adjust or control the placement of treatments and outcomes in the cognitive matrix interface 540. For example, the outcome importance data can be used to control the content displayed in the optimized visualization 540 by placing more important treatment outcomes in locations that draw more user attention (e.g., at the top of the screen 540). In the case of limited display space, a threshold value may be applied to filter less important outcomes and display only those outcomes having outcome importance data that exceeds the threshold value. In addition or in the alternative, the outcome impact data can be used to control the content displayed in the optimized visualization 540 by adjusting the visualization attributes, such as the intensity of color and the size of colored spot, to emphasize on the impact factor. For example, an outcome with high impact may be shown using bright red color when outcomes less impact are shown in light pink.

Selected embodiments of the present disclosure are described with reference to a QA system for displaying optimized treatment recommendations and outcomes on the basis of patient-specified input parameters (e.g., patient profile and medical data, patient-specified importance and impact factors, etc.), though other information handling systems or computing devices may be used. However implemented, it will be appreciated that the present disclosure may employ a user interface to generate and display personalized treatment recommendations with associated treatment outcomes for visual comparison by optimally depicting tradeoff options between recommended treatments based on patient-specified input parameters which are used to analyze the treatment outcomes with a cognitive approach and then display the recommended treatments based on user profile and preferences which may be dynamically modified through interaction with the user interface to specify importance and impact weighting factors.

By now, it will be appreciated that there is disclosed herein a system, method, apparatus, and computer program product for displaying tradeoff options for a plurality of items to a user at a first information handling system having a processor and a memory. As disclosed, the system, method, apparatus, and computer program product generate a plurality items (e.g., recipes, automobiles, services, products, and medical treatment recommendations) and associated options (e.g., cost or side effect characteristics for each item which have potential impact on the user) based on specified input parameters. In selected embodiments, each item is a recommended medical treatment for the user, and each option is a treatment outcome associated with a recommended medical treatment. For example, the plurality of items may be generated as a plurality of recommended medical treatments based on patient profile and medical data contained in the specified input parameters. Once the plurality of items (treatments) and options (outcomes) are generated, user-specified preference data is obtained for at least one of the associated options, such as by presenting a user interface with input controls for creating, viewing, updating, and deleting treatment outcomes for a recommended medical treatment, including specifying or modifying weighting factors specifying the importance or impact of outcomes for the user. In addition, the first information handling system applies natural language processing (NLP) analysis to the associated options based on the user-specified preference data and weighting factors to identify a list of options for a comparative list of items so that each option is shared in common with the comparative list of items. In selected embodiments, the NLP analysis may be applied by running a cognitive analysis against each treatment outcome associated with a recommended medical treatment based on the user-specified preference data and weighting factors which define a user tolerance for said treatment outcome. In such embodiments, the cognitive analysis may include performing a statistical modeling of the weighting factors based on a severity and incidence rate in relation to the treatment outcomes. In addition, the cognitive analysis may include performing a normalization based on the severity and incidence rate of the weighting factors. Once the comparative list of items and options are identified, the first information handling system may display a comparison of tradeoff options for the comparative list of items along with a visual tradeoff indication for each option shared in common with the comparative list of items. In selected embodiments, the comparison of tradeoff options is visually displayed as a treatment matrix of recommended medical treatments along a first item axis and associated treatment outcomes along a second option axis, where the treatment matrix includes visual tradeoff indications for each treatment outcome to assist with the comparison of tradeoff options for the recommended medical treatments. In selected embodiments, the system, method, apparatus, and computer program product also present a user interface with input controls for a medical provider to identify restrictions of treatment outcomes, patient history sources, and the representation of the treatment outcomes based on the normalization.

While particular embodiments of the present invention have been shown and described, it will be obvious to those skilled in the art that, based upon the teachings herein, changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method for improving operative function of an information handling system, comprising a processor and a memory, to enhance a display of tradeoff treatment effects for a plurality of medical treatment recommendations, the method comprising:
generating, by the first information handling system, a plurality of medical treatment recommendations and associated treatment effects based on specified input parameters;
obtaining, by the first information handling system, user-specified preference data for at least one of the associated treatment effects through user manipulation of a user interface slider control to adjust a weighting factor for personalizing a prioritization of the associated treatment effects;
applying, at the first information handling system, natural language processing (NLP) analysis to associated treatment effects based on the user-specified preference data and weighting factors to identify a list of treatment effects for a comparative list of medical treatment recommendations so that each treatment effect is shared in common with the comparative list of medical treatment recommendations; and
displaying, by the first information handling system, a comparison of tradeoff options comprising the comparative list of medical treatment recommendations and the list of treatment effects so that each treatment effect is shared in common with the comparative list of medical treatment recommendations, along with a visual tradeoff indication of relative severity for each treatment effect shared in common with the comparative list of medical treatment recommendations,
where each treatment effect comprises a negative side effect associated with receiving a medical treatment recommendation.

2. (canceled)

3. The method of claim 1, where the associated treatment effects for each medical treatment recommendation comprise cost or side effect characteristics for each medical treatment recommendation which have potential impact on the user.

4. (canceled)

5. The method of claim 1, where generating the plurality of medical treatment recommendations comprises generating a plurality of recommended medical treatments based on patient profile and medical data contained in the specified input parameters.

6. The method of claim 1, where obtaining user-specified preference data comprises presenting a user interface with input controls for creating, viewing, updating, and deleting treatment effects for a medical treatment recommendation.

7. The method of claim 1, where applying NLP analysis comprises running a cognitive analysis against each treatment effect associated with a medical treatment recommendation based on the user-specified preference data and weighting factors which define a user tolerance for said treatment effect.

8. The method of claim 7, where the cognitive analysis performs a statistical modeling of the weighting factors based on a severity and incidence rate in relation to the treatment effect.

9. The method of claim 8, where the cognitive analysis further performs a normalization based on the severity and incidence rate of the weighting factors.

10. The method of claim 9, further comprising presenting a user interface with input controls for a medical provider to identify restrictions of treatment effects, patient history sources, and the representation of the treatment effects based on the normalization.

11. The method of claim 1, where displaying the comparison of tradeoff options for the comparative list of medical treatment recommendations comprises displaying a treatment matrix of recommended medical treatments along a first axis and associated treatment effects along a second axis, where the treatment matrix includes visual tradeoff severity indications for each treatment effect to assist with the comparison of tradeoff options for the recommended medical treatments.

12. An information handling system comprising:
one or more processors;
a memory coupled to at least one of the processors;
a set of instructions stored in the memory and executed by at least one of the processors to display tradeoff treatment effects for a plurality of medical treatment options, wherein the set of instructions are executable to perform actions of:
generating, by the system, a plurality of medical treatment recommendations and associated treatment effects based on specified input parameters;
obtaining, by the system, user-specified preference data for at least one of the associated treatment effects through user manipulation of a displayed user interface slider control to adjust a weighting factor for personalizing a prioritization of the associated treatment effects;
applying, at the system, natural language processing (NLP) analysis to associated treatment effects based on the user-specified preference data, interaction data from similar users, and weighting factors to identify a list of treatment effects for a comparative list of medical treatment recommendations so that each treatment effect is shared in common with the comparative list of medical treatment recommendations; and
displaying, by the system, a comparison of tradeoff options comprising the comparative list of medical treatment recommendations and the list of treatment effects so that each treatment effect is shared in common with the comparative list of medical treatment recommendations, along with a visual tradeoff indication of relative severity for each treatment effect shared in common with the comparative list of medical treatment recommendations.

13. The information handling system of claim 12,
wherein the associated treatment effects for each medical treatment recommendation comprise cost, or side effect characteristics for each medical treatment recommendation which have potential impact on the user.

14. The information handling system of claim 12, wherein the set of instructions are executable to generate the plurality of medical treatment recommendations by generating a plurality of recommended medical treatments for the user based on patient profile and medical data contained in the specified input parameters.

15. The information handling system of claim 12, wherein the set of instructions are executable to obtain user-specified preference data by presenting a user interface with input controls for creating, viewing, updating, and deleting treatment effects for a medical treatment recommendation.

16. The information handling system of claim 12, wherein the set of instructions are executable to apply NLP analysis by running a cognitive analysis against each treatment effect associated with a medical treatment recommendation based on the user-specified preference data and weighting factors which define a user tolerance for said treatment effect.

17. The information handling system of claim 12, wherein the set of instructions are executable to display the comparison of tradeoff options for the comparative list of medical treatment recommendations by displaying a treatment matrix of recommended medical treatments along a first axis and associated treatment effects along a second axis, where the treatment matrix includes visual tradeoff severity indications for each treatment effect to assist with the comparison of tradeoff options for the recommended medical treatments.

18. A computer program product stored in a computer readable storage medium, comprising computer instructions that, when executed by an information handling system, causes the system to displaying tradeoff treatment effects for a plurality of medical treatment recommendations by:
generating, by the system, a plurality of medical treatment recommendations and associated treatment effects based on specified input parameters;
obtaining, by the system, user-specified preference data for at least one of the associated treatment effects which is received through user manipulation of a slider icon to adjust a weight used with the at least one of the associated treatment effects to personalize a prioritization of the associated treatment effects;
applying, at the system, natural language processing (NLP) analysis to associated treatment effects based on the user-specified preference data and weighting factors to identify a list of treatment effects for a comparative list of medical treatment recommendations so that each treatment effect is shared in common with the comparative list of medical treatment recommendations; and
displaying, by the system, a comparison of tradeoff options comprising the comparative list of medical treatment recommendations and the list of treatment effects so that each treatment effect is shared in common with the comparative list of medical treatment recommendations, along with a visual tradeoff indication of relative severity for each treatment effect shared in common with the comparative list of medical treatment recommendations, where the visual tradeoff indication comprises a color selected from a continuous range of colors in which darker colors visually signify more adverse side effects, while lighter colors visually signify less significant side effects.

19. The computer program product of claim 18, wherein generating the plurality of medical treatment recommendations and associated treatment effects comprises generating a plurality of recommended medical treatments for the user based on patient profile and medical data contained in the specified input parameters.

20. The computer program product of claim 18, wherein obtaining user-specified preference data comprises presenting a user interface with input controls for creating, viewing, updating, and deleting treatment effects for a medical treatment recommendation.

21. The computer program product of claim 18, wherein applying NLP analysis comprises running a cognitive analysis against each treatment effect associated with a medical treatment recommendation based on the user-specified preference data and weighting factors which define a user tolerance for said treatment effect.

22. The computer program product of claim 18, wherein displaying the comparison of tradeoff options for the comparative list of medical treatment recommendations comprises displaying a treatment matrix of recommended medical treatments along a first axis and associated treatment effects along a second axis, where the treatment matrix includes visual tradeoff severity indications for each treatment effect to assist with the comparison of tradeoff options for the recommended medical treatments.
